(19) United States
(12) Patent Application Publication
(10) Pub. No.: US 2021/0406655 A1
(43) Pub. Date: Dec. 30, 2021

(54) INFERENCE PROCESSING DEVICE AND INFERENCE PROCESSING METHOD

(71) Applicant: Nippon Telegraph and Telephone Corporation, Tokyo (JP)

(72) Inventors: Huycu Ngo, Tokyo (JP); Yuki Arikawa, Tokyo (JP); Takeshi Sakamoto, Tokyo (JP); Yasue Kishino, Tokyo (JP)

(73) Assignee: Nippon Telegraph and Telephone Corporation, Tokyo (JP)

(21) Appl. No.: 17/293,736

(22) PCT Filed: Dec. 25, 2019
(86) PCT No.: PCT/JP2019/050832

§ 371 Date: May 13, 2021

(30) Foreign Application Priority Data
Jan. 9, 2019 (JP) 2019-001590

(51) Int. Cl. G06N 3/063; G06N 3/08

(52) U.S. Cl. CPC G06N 3/063; G06N 3/08

(57) ABSTRACT

An inference processing apparatus includes an input data storage unit that stores pieces of input data, a learned storage unit that stores a piece of weight data of a neural network, a batch processing control unit that sets a batch size in accordance with information on the pieces of input data, a memory control unit that reads out, from the input data storage unit, the pieces of input data corresponding to the set batch size, and an inference operation unit that batch-processes operation in the neural network using, as input, the pieces of input data corresponding to the batch size and the piece of weight data and infers a feature of the pieces of input data.

### CROSS-REFERENCE TO RELATED APPLICATIONS

This application is a national phase entry of PCT Application No. PCT/JP2019/050832, filed on Dec. 25, 2019, which claims priority to Japanese Application No. 2019-001590, filed on Jan. 9, 2019, which applications are hereby incorporated herein by reference.

### TECHNICAL FIELD

The present invention relates to an inference processing apparatus and an inference processing method and particularly to a technique for performing inference using a neural network.

### BACKGROUND

In recent years, pieces of data generated have been increasing explosively with increase in edge devices, such as mobile terminals and Internet of Things (IoT) devices. A most-advanced machine learning technique called Deep Neural Networks (DNN) has an advantage in extracting meaningful information from vast amounts of data. Data analysis precision has been significantly improved through recent advances in studies on DNN, and techniques using DNN are expected to develop further.

DNN processing has the two phases: learning; and inference. Generally, learning needs large amounts of data, and the large amounts of data may be processed on the cloud. In contrast, inference uses a learned DNN model and estimates an output for unknown input data.

To be more specific, in inference processing in a DNN, input data, such as time-series data or image data, is given to a learned neural network model to infer a feature of the input data. For example, according to a concrete example disclosed in Non-Patent Literature 1, the amount of garbage is estimated by detecting an event, such as rotation or suspension, of a garbage truck using a sensor terminal equipped with an acceleration sensor and a gyroscope sensor. As described above, to estimate an event at each time using, as input, unknown time-series data, a neural network model which is learned in advance using time-series data, in which an event at each time is known, is used.

Non-Patent Literature 1 uses, as input data, time-series data which is acquired from the sensor terminal and needs to extract an event in real time. It is thus necessary to speed up inference processing. For this reason, speeding up of processing has been achieved by equipping a sensor terminal with an FPGA which implements inference processing and performing inference operation by the FPGA (see Non-Patent Literature 2).

### CITATION LIST

### Non-Patent Literature

Non-Patent Literature 1: Kishino et al., “Detecting garbage collection duration using motion sensors mounted on a garbage truck toward smart waste management,” SPWID17.
Non-Patent Literature 2: Kishino et al., “Datafying city: detecting and accumulating spatio-temporal events by vehicle-mounted sensors,” BIGDATA 2017.

### SUMMARY

### Technical Problem

Conventional techniques, however, need to read out, for each data set as an object of inference processing, input data and a weight for a neural network model from memory and transfer the input data and the weight to a circuit which performs inference operation, at the time of inference processing. For this reason, if the amounts of data handled increase, data transfer becomes a bottleneck, which makes a processing time period for inference operation difficult to reduce.

Embodiments of the present invention have been made to solve the above-described problem, and has as its object to provide an inference processing technique capable of eliminating a bottleneck in data transfer and reducing a processing time period for inference operation.

### Means for Solving the Problem

To solve the above-described problem, an inference processing apparatus according to embodiments of the present invention includes a first storage unit that stores input data, a second storage unit that stores a weight for a neural network, a batch processing control unit that sets a batch size on the basis of information on the input data, a memory control unit that reads out, from the first storage unit, a piece of the input data corresponding to the set batch size, and an inference operation unit that batch-processes operation in the neutral network using, as input, the piece of the input data corresponding to the batch size and the weight and infers a feature of the piece of the input data.

In the inference processing apparatus according to embodiments of the present invention, the batch processing control unit may set the batch size on the basis of information on hardware resources used for inference operation.

In the inference processing apparatus according to embodiments of the present invention, the inference operation unit may include a matrix operation unit that performs matrix operation of the piece of the input data and the weight and an activation function operation unit that applies an activation function to a matrix operation result from the matrix operation unit, and the matrix operation unit may have a multiplier that multiplies the piece of the input data and the weight and an adder that adds a multiplication result from the multiplier.

In the inference processing apparatus according to embodiments of the present invention, the matrix operation unit may include a plurality of matrix operation units, and the plurality of matrix operation units may perform matrix operation in parallel.

In the inference processing apparatus according to embodiments of the present invention, the multiplier and the adder that the matrix operation unit has may include a plurality of multipliers and a plurality of adders, respectively, and the plurality of multipliers and the plurality of adders may perform multiplication and addition in parallel.

The inference processing apparatus according to embodiments of the present invention may further include a data conversion unit that converts data types of the piece of the input data and the weight to be input to the inference operation unit.

In the inference processing apparatus according to embodiments of the present invention, the inference operation unit may include a plurality of inference operation units, and the plurality of inference operation units may perform inference operation in parallel.

To solve the above-described problem, an inference processing method according to embodiments of the present invention includes a first step of setting a batch size on the basis of information on input data that is stored in a first storage unit, a second step of reading out, from the first storage unit, a piece of the input data corresponding to the set batch size, and a third step of batch-processing operation in a neural network using, as input, the piece of the input data corresponding to the batch size and a weight of the neural network that is stored in a second storage unit and inferring a feature of the piece of the input data.

### Effects of Embodiments of the Invention

According to embodiments of the present invention, operation in a learned neural network is batch-processed using, as input, a piece of input data corresponding to a batch size which is set on the basis of information on the input data and a weight. It is thus possible to eliminate a bottleneck in data transfer and reduce a processing time period for inference operation even if the amounts of data handled increase.

### BRIEF DESCRIPTION OF THE DRAWINGS

FIG. 1 is a block diagram showing a configuration of an inference processing apparatus according to a first embodiment of the present invention.

FIG. 2 is a block diagram showing a configuration of a storage unit according to the first embodiment.

FIG. 3 is a block diagram showing a configuration of an inference operation unit according to the first embodiment.

FIG. 4 is a block diagram showing a configuration of a matrix operation unit according to the first embodiment.

FIG. 5 is a block diagram showing a hardware configuration of the inference processing apparatus according to the first embodiment.

FIG. 6 is a view for explaining an example of sample code of an inference processing program according to the first embodiment.

FIG. 7A is a diagram for explaining inference processing using a neural network according to the first embodiment.

FIG. 7B is a view for explaining the inference processing using the neural network according to the first embodiment.

FIG. 8 is a flowchart for explaining action of the inference processing apparatus according to the first embodiment.

FIG. 9 is a flowchart for explaining a batch size setting process according to the first embodiment.

FIG. 10 is a diagram for explaining data transfer in an inference processing apparatus of a conventional example.

FIG. 11 is a diagram for explaining data transfer in the inference processing apparatus according to the first embodiment.

FIG. 12 is a graph for explaining an effect of the first embodiment.

FIG. 13 is a block diagram showing a configuration of an inference processing apparatus according to a second embodiment.

FIG. 14 is a flowchart for explaining action of the inference processing apparatus according to the second embodiment.

FIG. 15 is a diagram for explaining an effect of the second embodiment.

FIG. 16 is a block diagram showing a configuration of an inference processing apparatus according to a third embodiment.

FIG. 17 is a block diagram showing a configuration of an inference operation unit according to a fourth embodiment.

FIG. 18 is a block diagram showing a configuration of a matrix operation unit according to a fifth embodiment.

FIG. 19 is a block diagram showing a configuration of an inference processing apparatus according to a sixth embodiment.

FIG. 20 is a block diagram showing a configuration of the inference processing apparatus according to the conventional example.

### DETAILED DESCRIPTION OF ILLUSTRATIVE EMBODIMENTS

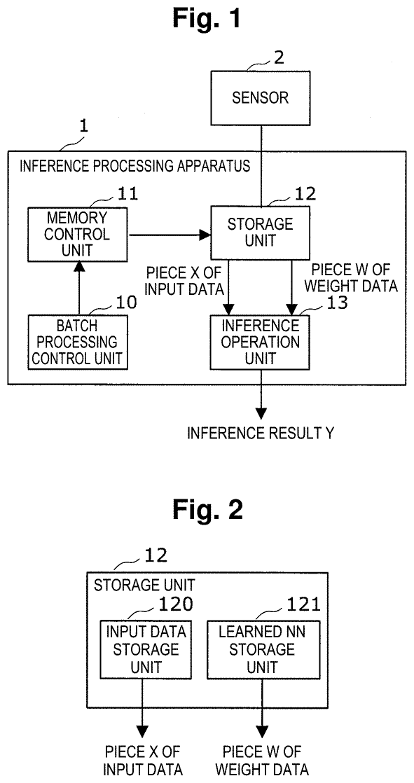

Preferred embodiments of the present invention will be described below in detail with reference to FIGS. 1 to 20.

### First Embodiment

FIG. 1 is a block diagram showing a configuration of an inference processing apparatus 1 according to a first embodiment of the present invention. The inference processing apparatus 1 according to the present embodiment uses, as pieces X of input data as an object of inference, time-series data, such as voice data or language data, or image data which is acquired from an external sensor 2 or the like, as shown in FIG. 1. The inference processing apparatus 1 batch-processes neural network operation using a learned neural network model and infers a feature of the pieces X of input data.

To be more specific, the inference processing apparatus 1 uses a neural network model which is learned in advance using pieces X of input data, such as time-series data, in which an event at each time is known. The inference processing apparatus 1 uses, as input, pieces X of input data, such as unknown time-series data, corresponding to a set batch size and a piece W of weight data of the learned neural network to estimate an event at each time through batch processing. Note that the pieces X of input data and the piece W of weight data are pieces of matrix data.

For example, the inference processing apparatus 1 can estimate the amount of garbage by batch-processing pieces X of input data acquired from a sensor 2 which is equipped with an acceleration sensor and a gyroscopic sensor and detecting an event, such as rotation or suspension of a garbage truck (see Non-Patent Literature 1).

Configuration of Inference Processing Apparatus

The inference processing apparatus 1 includes a batch processing control unit 10, a memory control unit 11, a storage unit 12, and an inference operation unit 13, as shown in FIG. 1.

The batch processing control unit 10 sets a batch size for batch-processing pieces X of input data by the inference operation unit 13, on the basis of information on pieces X of input data. The batch processing control unit 10 sends, to the memory control unit 11, an instruction to read out pieces X of input data corresponding to the set batch size from the storage unit 12.

For example, the batch processing control unit 10 can set the number of pieces X of input data to be handled by one batch process, i.e., the batch size on the basis of information on hardware resources used for inference operation (to be described later).

Alternatively, the batch processing control unit 10 can set the batch size on the basis of a matrix size for a piece W of weight data of a neural network model which is stored in the storage unit 12 or a matrix size for pieces X of input data.

In addition to the above-described examples, the batch processing control unit 10 can, for example, optimize a data transmission and reception time period and a data operation time period and set an optimum batch size on the basis of balance between the transmission and reception time period and the operation time period. The batch processing control unit 10 may set the batch size on the basis of a processing time period and inference precision for the whole inference processing apparatus 1.

The memory control unit 11 reads out pieces X of input data corresponding to the batch size set by the batch processing control unit 10 from the storage unit 12. The memory control unit 11 also reads out the piece W of weight data of the neural network from the storage unit 12. The memory control unit 11 transfers the pieces X of input data and the piece W of weight data that are read out to the inference operation unit 13.

The storage unit 12 includes an input data storage unit (first storage unit) 120 and a learned neural network (NN) storage unit (second storage unit) 121, as shown in FIG. 2.

Pieces X of input data, such as time-series data acquired from the sensor 2, are stored in the input data storage unit 120.

A learned neural network which is learned and built in advance, i.e., a piece W of weight data of the neural network is stored in the learned NN storage unit 121. For example, the piece W of weight data that is determined through learning performed in advance in an external server or the like is loaded and is stored in the learned NN storage unit 121.

Note that, for example, a publicly known neural net model having at least one intermediate layer, such as a convolutional neural network (CNN), a long short-term memory (LSTM), a gated recurrent unit (GRU), a Residual Network (ResNet) CNN, or a neural network which is a combination thereof can be used as a neural network model which is adopted in the inference processing apparatus 1.

The sizes of each piece X of input data and the piece W of weight data which are matrices are determined by a neural network model used in the inference processing apparatus 1. The piece X of input data and the piece W of weight data are represented in, for example, 32-bit floating-point format.

The inference operation unit 13 uses, as input, pieces X of input data corresponding to the set batch size and the piece W of weight data to batch-process neural network operation and infers a feature of the pieces X of input data. To be more specific, the pieces X of input data and the piece W of weight data that are read out and transferred by the memory control unit 11 are input to the inference operation unit 13, and inference operation is performed.

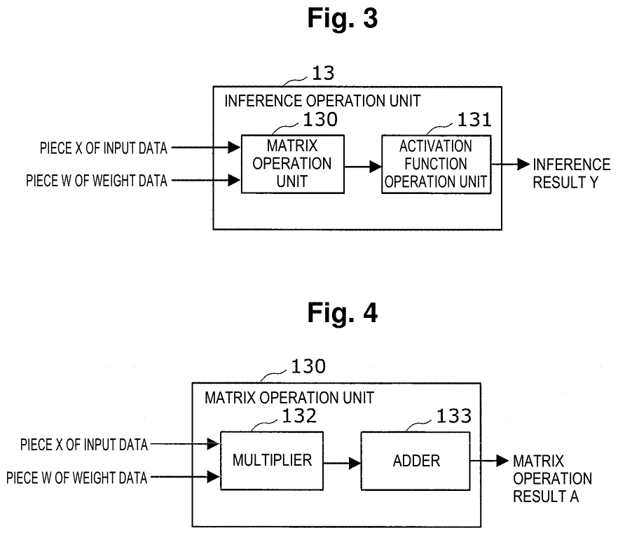

The inference operation unit 13 includes a matrix operation unit 130 and an activation function operation unit 131, as shown in FIG. 3. The matrix operation unit 130 has a multiplier 132 and an adder 133, as shown in FIG. 4.

The matrix operation unit 130 performs matrix operation of pieces X of input data and the piece W of weight data. To be more specific, the multiplier 132 performs multiplication of each piece X of input data and the piece W of weight data, as shown in FIG. 4. Multiplication results are added up by the adder 133, and an addition result is output. The addition result is output as a matrix operation result A from the matrix operation unit 130.

The matrix operation result A is input to the activation function operation unit 131, an activation function which is set in advance is applied, and an inference result Y as a result of inference operation is determined. More concretely, the activation function operation unit 131 determines how the matrix operation result A is activated by the application of the activation function, and converts the matrix operation result A and outputs the inference result Y. The activation function can be selected from among, for example, a step function, a sigmoid function, a tan h function, a ReLU function, a softmax function, and the like.

Hardware Configuration of Inference Processing Apparatus

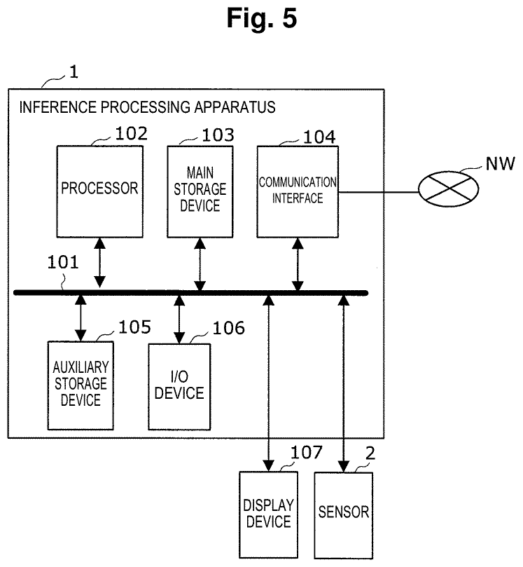

An example of a hardware configuration of the inference processing apparatus 1 having the above-described configuration will be described with reference to FIG. 5.

As shown in FIG. 5, the inference processing apparatus 1 can be implemented by, for example, a computer including a processor 102, a main storage device 103, a communication interface 104, an auxiliary storage device 105, and an I/O device 106 which are connected via a bus 101 and a program which controls these hardware resources. For example, a display device 107 may be connected to the inference processing apparatus 1 via the bus 101 and may display an inference result and the like on a display screen. The sensor 2 may be connected via the bus 101 and may measure pieces X of input data made of time-series data, such as voice data, which is an object of inference in the inference processing apparatus 1.

The main storage device 103 is implemented by one of semiconductor memories, such as an SRAM, a DRAM, and a ROM. The main storage device 103 implements the storage unit 12 described with reference to FIG. 1.

A program for the processor 102 to perform various types of control and operation is stored in advance in the main storage device 103. Functions of the inference processing apparatus 1 including the batch processing control unit 10, the memory control unit 11, and the inference operation unit 13 shown in FIGS. 1 to 4 are implemented by the processor 102 and the main storage device 103.

The communication interface 104 is an interface circuit for communication with various types of external electronic instruments via a communication network NW. The inference processing apparatus 1 may receive a piece W of weight data of a learned neural network from the outside or send out an inference result Y to the outside, via the communication interface 104.

For example, an interface and an antenna which support a wireless data communication standard, such as LTE, 3G, a wireless LAN, or Bluetooth®, are used as the communication interface 104. The communication network NW includes a WAN (Wide Area Network) or a LAN (Local Area Network), the Internet, a dedicated line, a wireless base station, a provider, and the like.

The auxiliary storage device 105 is composed of a readable/writable storage medium and a drive device for reading/writing various types of information, such as a program and data, from/to the storage medium. A semiconductor memory, such as a hard disk or a flash memory, can be used as the storage medium in the auxiliary storage device 105.

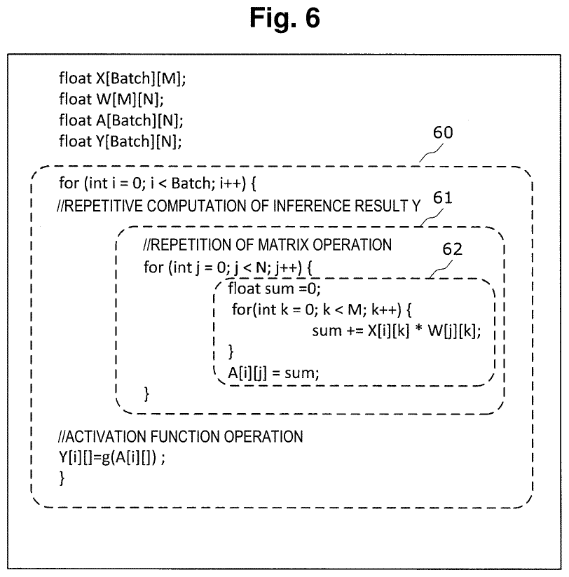

The auxiliary storage device 105 has a program storage region where a program for the inference processing apparatus 1 to perform inference through batch processing is stored. The auxiliary storage device 105 may further has, for example, a backup region for backing up the data and program described above. The auxiliary storage device 105 can store, for example, an inference processing program shown in FIG. 6.

The I/O device 106 is composed of an I/O terminal which receives a signal input from an external instrument, such as the display device 107, or outputs a signal to the external instrument.

Note that the inference processing apparatus 1 is not always implemented by one computer and may be dispersed by a plurality of computers which are interconnected by the communication network NW. The processor 102 may be implemented by hardware, such as an FPGA (Field-Programmable Gate Array), an LSI (Large Scale Integration), or an ASIC

### (Application Specific Integrated Circuit).

A circuit configuration can be flexibly rewritten in accordance with a configuration of a piece X of input data and a neural network model to be used especially by constructing the inference operation unit 13 using a rewritable gate array, such as an FPGA. In this case, the inference processing apparatus 1 capable of dealing with various applications can be implemented.

Outline of Inference Processing Method

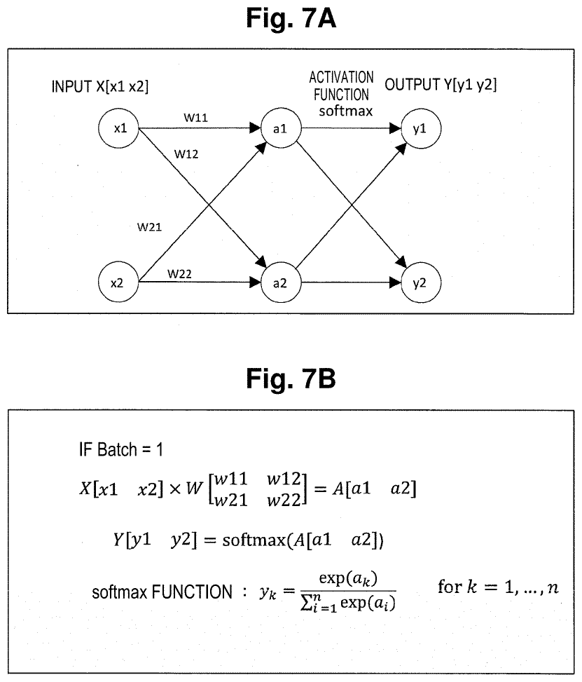

The outline of inference processing on a piece X of input data by the inference processing apparatus 1 according to the present embodiment will be described using a concrete example shown in FIGS. 7A and 7B.

A description will be given taking, as an example, a neural network which is composed of three layers: an input layer; an intermediate layer; and an output layer, as shown in FIG. 7A. A softmax function shown in FIG. 7B is used as the activation function. A feature of a piece X of input data as an object of inference is represented as M (M is a positive integer) elements, and a feature of an inference result Y is represented as N (N is a positive integer) elements. The data size of the piece W of weight data of the neural network is represented as M×N.

As indicated by the concrete example in FIGS. 7A and 7B, assume that M=N=2. For descriptive simplicity, a batch size Batch to be handled by one batch process which is set by the batch processing control unit 10 is set at 1. In this case, the piece X of input data corresponding to the batch size Batch (=1) is X[x1,x2]. The piece W of weight data is represented as a two-by-two matrix with four elements.

As shown in FIG. 7B, matrix product-sum operation of the piece X of input data corresponding to the batch size Batch (=1) and the piece W of weight data is first performed, and a matrix operation result A is obtained. The data size of the matrix operation result A is Batch×N, i.e., 1×2. After that, the softmax function as the activation function is applied to the matrix operation result A, and an inference result Y is calculated.

An inference result (inference results) Y with a data count corresponding to the set batch size Batch is (are) output for a piece (pieces) X of input data with a data count corresponding to the batch size Batch. Thus, in the example in FIGS. 7A and 7B, an inference result Y[y1,y2] as one set is output for the piece X[x1,x2] of input data as one set corresponding to Batch (=1). Note that the batch size Batch has a value within a range of 1 to a data count of a piece (pieces) X of input data.

In operation processing of the activation function, the softmax function is applied to a value aₖ (k=1, . . . , n) of each element of the matrix operation result A, and a value of each element yₖ (k=1, . . . , n) of the inference result Y is calculated. In the concrete example shown in FIGS. 7A and 7B, the softmax function is applied to each element of the matrix operation result A[a1,a2] (softmax(A[a1,a2])), and the inference result Y[y1,y2] is output.

Note that a process of repeatedly performing inference operation through batch processing of pieces X of input data in accordance with the set batch size and outputting an inference result Y is indicated by a broken frame 60 in sample code in FIG. 6. In the inference operation, products of elements in a row of a piece X of input data and elements in a column of the piece W of weight data and the sum of the products are computed (see broken frames 61 and 62 in the sample code in FIG. 6).

Action of Inference Processing Apparatus

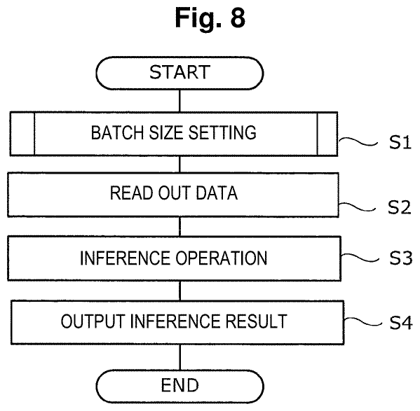

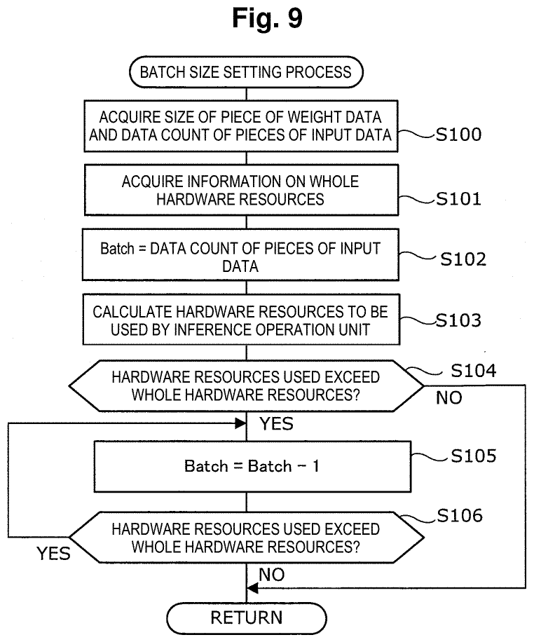

Action of the inference processing apparatus 1 according to the present embodiment will be described in more detail with reference to the flowcharts in FIGS. 8 and 9. The following description assumes that a piece W of weight data of a neural network which is learned and built in advance is stored in the storage unit 12. Also, assume that pieces X of input data, such as time-series data or image data, measured by the external sensor 2 are held in the storage unit 12.

As shown in FIG. 8, the batch processing control unit 10 sets a batch size for pieces X of input data to be handled by one batch process (step S1).

To be more specific, the batch processing control unit 10 acquires information on the data size of the piece W of weight data and a data count of the pieces X of input data stored in the storage unit 12 (step S100), as shown in FIG. 9. The batch processing control unit 10 then acquires information on hardware resources in the whole inference processing apparatus 1 from the storage unit 12 (step S101). Note that the information on the hardware resources of the whole inference processing apparatus 1 is stored in advance in the storage unit 12.

Hardware resources here refer to, e.g., memory capacity required to store pieces X of input data and a piece W of weight data and a combinational circuit with standard cells required to construct a circuit for operation processing, such as addition and multiplication. For example, in the case of an FPGA, a flip-flop (FF), a lookup table (LUT), and a combinational circuit, such as a digital signal processor (DSP), are taken as examples of hardware resources.

In step S101, memory capacity in the whole inference processing apparatus 1 and the device size of the whole inference processing apparatus 1, i.e., the number of hardware resources which the whole inference processing apparatus 1 includes as operational circuits (e.g., the number of FFs, LUTs, DSPs, and the like in the case of an FPGA) are acquired from the storage unit 12.

The batch processing control unit 10 sets, as an initial value for the batch size to be handled by one batch process, a total data count of the pieces X of input data (step S102). That is, in step S102, the total data count of the pieces X of input data that is a maximum value for the batch size is set as the initial value for the batch size.

After that, hardware resources required for a circuit configuration which implements the inference operation unit 13 are calculated on the basis of the data size of the piece W of weight data and the data count of the pieces X of input data acquired in step S100, information on the hardware resources of the whole inference processing apparatus 1 acquired in step S101, and the batch size set in step S102 (step S103). For example, the batch processing control unit 10 can build a logic circuit of the inference operation unit 13 and acquire hardware resources to be used.

If the number of hardware resources to be used when the inference operation unit 13 performs inference operation exceeds the number of hardware resources which the whole inference processing apparatus 1 includes (YES in step S104), the batch processing control unit 10 reduces the batch size initialized in step S102 (step S105). For example, the batch processing control unit 10 decrements the initialized batch size by 1.

After that, if the number of hardware resources for the inference operation unit 13 that is calculated on the basis of the smaller batch size is not more than the number of hardware resources of the whole inference processing apparatus 1 (NO in step S106), the batch size is used as a set value, and the process returns to FIG. 8. To be more specific, the batch processing control unit 10 instructs the memory control unit 11 to read out a piece (pieces) X of input data corresponding to the set batch size.

Note that, if the number of hardware resources to be used when the inference operation unit 13 performs inference operation in step S106 exceeds the number of hardware resources which the whole inference processing apparatus 1 includes (YES in step S106), the batch processing control unit 10 performs a process of reducing the batch size again (step S105).

After that, the memory control unit 11 reads out the piece (pieces) X of input data corresponding to the set batch size and the piece W of weight data from the storage unit 12 (step S2). To be more specific, the memory control unit 11 reads out the piece (pieces) X of input data and the piece W of weight data from the storage unit 12 and transfers the piece (pieces) X of input data and the piece W of weight data to the inference operation unit 13.

The inference operation unit 13 then batch-processes neural network operation on the basis of the piece (pieces) X of input data and the piece W of weight data and calculates an inference result Y (step S3). To be more specific, product-sum operation of the piece (pieces) X of input data and the piece W of weight data is performed in the matrix operation unit 130. Concretely, the multiplier 132 performs multiplication of the piece (pieces) X of input data and the piece W of weight data. A multiplication result (multiplication results) is (are) added up by the adder 133, and a matrix operation result A is calculated. The activation function is applied to the matrix operation result A by the activation function operation unit 131, and the inference result Y is output (step S4).

With the above-described processing, the inference processing apparatus 1 can use, as pieces X of input data, time-series data, such as image data or voice, to infer a feature of the pieces X of input data using the learned neural network.

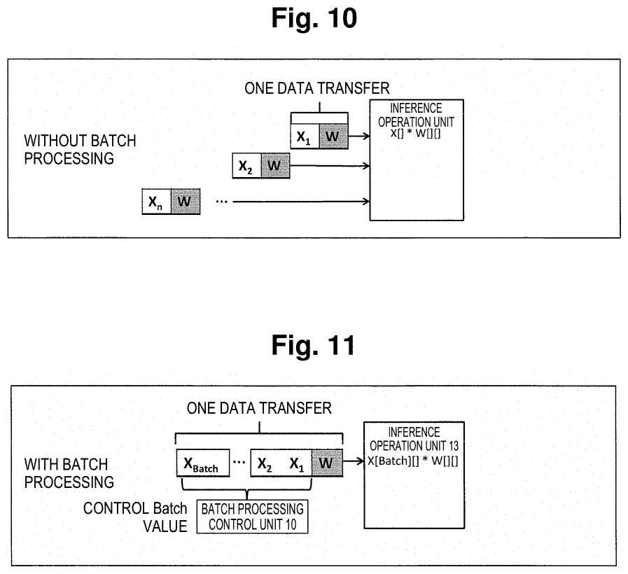

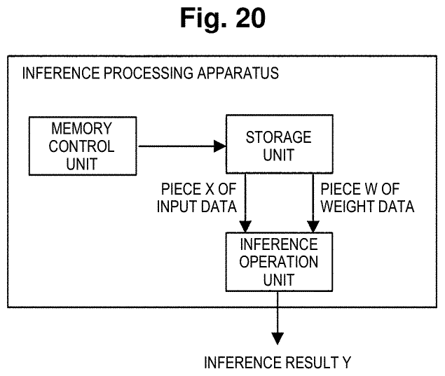

An effect of the batch processing control unit 10 according to the present embodiment will be described with reference to FIGS. 10 and 11 and FIG. 20. For comparison, an inference processing apparatus without the batch processing control unit 10 according to the present embodiment will be described first as an inference processing apparatus (FIG. 20) of a conventional example. As shown in FIG. 10, when n (n is a positive integer) pieces X of input data are processed, the inference processing apparatus according to the conventional example needs to transfer a piece W of weight data to an inference operation unit n times.

In contrast, in the inference processing apparatus 1 including the batch processing control unit 10 according to the present embodiment, the batch processing control unit 10 sets the batch size Batch to be processed by one inference operation and collectively processes pieces X of input data corresponding to the set batch size, as shown in FIG. 11. For this reason, even if there are, for example, n pieces X of input data, the piece W of weight data only needs to be transferred to the inference operation unit 13 (n/Batch) times. If Batch=n, the piece W of weight data needs to be transferred to the inference operation unit 13 only once. Thus, a load on a bus band in the inference processing apparatus 1 can be reduced.

The inference processing apparatus 1 according to the present embodiment can perform a relatively large-scale matrix computation through batch processing, and computational speed is higher than that at the time of execution of divided smaller-scale matrix computations. This allows speeding up of inference operation.

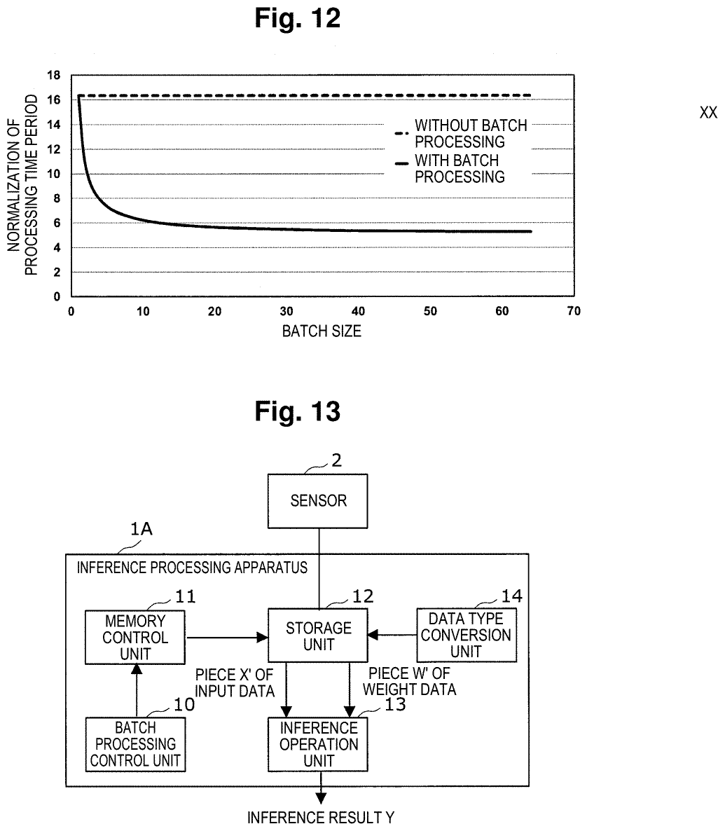

FIG. 12 shows an effect due to batch processing of the present embodiment in a case where the data size of the piece W of weight data is 30×30. In FIG. 12, a broken line indicates a relationship between a batch size and a normalized processing time period for inference operation in a case where batch processing is not performed while a solid line indicates a relationship between a batch size and a normalized processing time period for inference operation in a case where batch processing according to the present embodiment is performed. As can be seen from FIG. 12, a processing time period is shorter in the case where the batch processing according to the present embodiment is performed than in the case without batch processing.

As has been described above, the inference processing apparatus 1 according to the first embodiment sets the batch size for pieces X of input data to be handled by one batch process on the basis of hardware resources to be used by the inference operation unit 13 with respect to the hardware resources of the whole inference processing apparatus 1. It is thus possible to eliminate a bottleneck in data transfer and reduce a processing time period required for inference operation even if the amounts of data handled increase.

### Second Embodiment

A second embodiment of the present invention will be described. Note that the same components as those in the above-described first embodiment are denoted by the same reference numerals in the description below and that a detailed description thereof will be omitted.

The first embodiment has described a case where the inference operation unit 13 executes, for example, inference operation of pieces X of input data and a piece W of weight data which are of 32-bit floating-point type. In contrast, in the second embodiment, inference operation is executed after data input to an inference operation unit 13 is converted into data of lower bit precision in terms of a bit representation. A description will be given below with a focus on components different from those in the first embodiment.

Configuration of Inference Processing Apparatus

FIG. 13 is a block diagram showing a configuration of an inference processing apparatus 1A according to the present embodiment.

The inference processing apparatus 1A includes a batch processing control unit 10, a memory control unit 11, a storage unit 12, the inference operation unit 13, and a data type conversion unit (data conversion unit) 14.

The data type conversion unit 14 converts the data types of pieces X of input data and a piece W of weight data which are input to the inference operation unit 13. To be more specific, the data type conversion unit 14 converts the data types of the pieces X of input data and the piece W of weight data which are read out from the storage unit 12 and are transferred to the inference operation unit 13 by the memory control unit 11 from 32-bit floating-point type into a data type set in advance, such as a reduced-precision data representation with a reduced number of digits (e.g., 8 bits or 16 bits). The data type conversion unit 14 can convert the pieces X of input data and the piece W of weight data with respective decimal points into integer type by performing rounding processing, such as roundup, rounddown, or roundoff.

Note that the data type conversion unit 14 can convert the data types of the pieces X of input data and the piece W of weight data that are read out by the memory control unit 11 through access to the storage unit 12, before transfer. The data type conversion unit 14 may convert the pieces X of input data and the piece W of weight data into data types, respectively, with different bit representations as long as the pieces X of input data and the piece W of weight data can be made to have bit precisions lower than those for the original data types.

The memory control unit 11 transfers, to the inference operation unit 13, pieces X′ of input data and a piece W′ of weight data which are reduced in bit precision through the data type conversion by the data type conversion unit 14. To be more specific, the memory control unit 11 reads out, from the storage unit 12, pieces X of input data corresponding to a batch size which is set by the batch processing control unit 10 and a piece W of weight data which is stored in advance in the storage unit 12. After that, the data types of the pieces X of input data and the piece W of weight data that are read out are converted by the data type conversion unit 14, and pieces X′ of input data and the piece W′ of weight data after the conversion are transferred to the inference operation unit 13.

Action of Inference Processing Apparatus

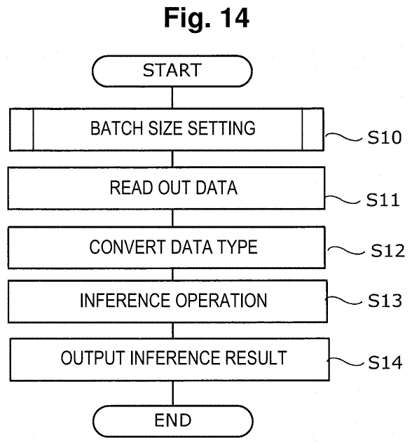

Action of the inference processing apparatus 1A having the above-described configuration will be described with reference to the flowchart in FIG. 14. The following description assumes that a piece W of weight data of a neural network which is learned and built in advance is stored in the storage unit 12. Also, assume that the piece W of weight data and pieces X of input data which are acquired from a sensor 2 and stored in the storage unit 12 are both pieces of data of 32-bit floating-point type.

As shown in FIG. 14, the batch processing control unit 10 sets a batch size for pieces X of input data to be handled by one batch process (step S10). Note that the batch size setting process is the same as that in the first embodiment (FIG. 9).

After that, the memory control unit 11 reads out a piece (pieces) X of input data corresponding to the batch size set by the batch processing control unit 10 and the piece W of weight data from the storage unit 12 (step S11). The data type conversion unit 14 converts the data types of the piece (pieces) X of input data and the piece W of weight data read out by the memory control unit 11 (step S12).

More concretely, the data type conversion unit 14 converts the piece (pieces) X of input data and the piece W of weight data that are of 32-bit floating-point type into pieces of data of lower bit precision, e.g., a piece (pieces) X′ of input data and the piece W′ of weight data which are 8 bits long. The piece (pieces) X′ of input data and the piece W′ of weight data after the data type conversion are transferred to the inference operation unit 13 by the memory control unit 11.

After that, the inference operation unit 13 batch-processes neural network operation on the basis of the piece (pieces) X′ of input data and the piece W′ of weight data after the conversion into pieces of data of low bit precision and calculates an inference result Y (step S13). To be more specific, product-sum operation of the piece (pieces) X′ of input data and the piece W′ of weight data is performed in the matrix operation unit 130. Concretely, a multiplier 132 performs multiplication of the piece (pieces) X′ of input data and the piece W′ of weight data. A multiplication result (multiplication results) is (are) added up by an adder 133, and a matrix operation result A is calculated. An activation function is applied to the matrix operation result A by an activation function operation unit 131, and an inference result Y is output (step S14).

With the above-described processing, the inference processing apparatus 1A can use, as pieces X of input data, time-series data, such as image data or voice, to infer a feature of the pieces X of input data using the learned neural network.

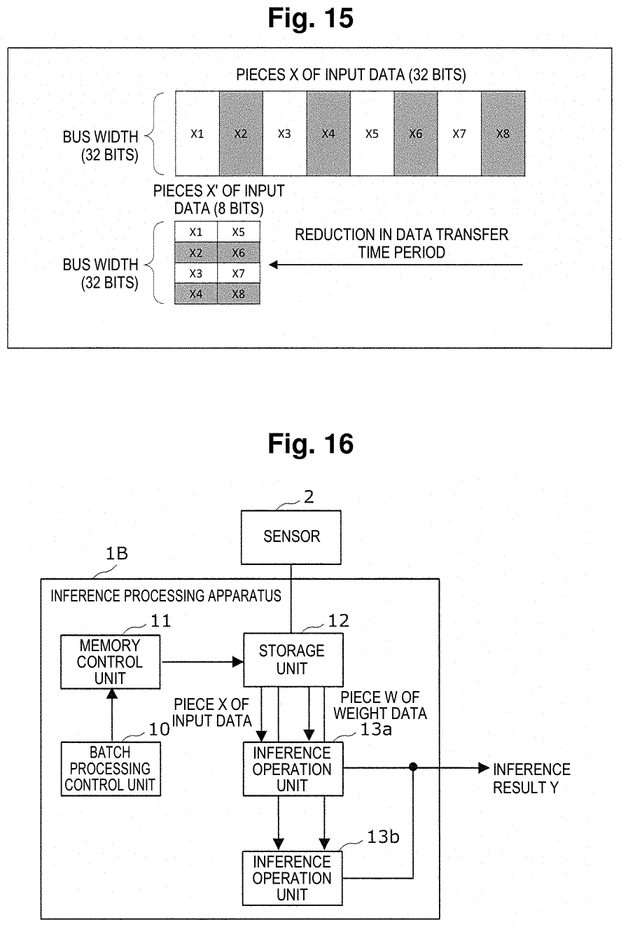

A data transfer time period in the inference processing apparatus 1A according to the present embodiment will be described with reference to FIG. 15. As indicated by an upper portion in FIG. 15, if a bus width is 32 bits wide, only one piece of 32-bit data can be transferred at the time of transmission of pieces X of 32-bit input data. If a piece X of 32-bit input data is converted into pieces X′ of 8-bit input data, as indicated by a lower portion in FIG. 15, four pieces of 8-bit data can be transferred.

As described above, since the memory control unit 11 transfers pieces of data after conversion into pieces of data of low bit precision when the memory control unit 11 reads out pieces X of input data and the piece W of weight data from the storage unit 12 and transfers the pieces X of input data and the piece W of weight data, a transfer time period can be reduced.

As has been described above, the inference processing apparatus 1A according to the second embodiment converts pieces X of input data and the piece W of weight data which are input to the inference operation unit 13 into pieces of data of lower bit precision. This allows improvement in cache utilization and reduction in bottlenecks in a data bus band.

Additionally, since the inference processing apparatus 1A performs neural network operation using pieces X′ of input data and the piece W′ of weight data of low bit precision, the number of multipliers 132 and adders 133 required for operation can be reduced. As a result, the inference processing apparatus 1A can be implemented by less hardware resources, and the circuit size of the whole apparatus can be reduced.

In addition, since the inference processing apparatus 1A can reduce hardware resources to be used, power consumption and heat generation can be reduced.

Moreover, the inference processing apparatus 1A performs neural network operation using pieces X′ of input data and the piece W′ of weight data of lower bit precision. Processing can be performed on a higher clock frequency, which allows faster processing.

Further, the inference processing apparatus 1A performs neural network operation using pieces X′ of input data and the piece W′ of weight data of lower bit precision than 32 bits. This allows a higher degree of parallelization and more batch processes, and faster processing than in a case where operation is performed at 32 bits.

### Third Embodiment

A third embodiment of the present invention will be described. Note that the same components as those in the above-described first and second embodiments are denoted by the same reference numerals in the following description and that a description thereof will be omitted.

The first and second embodiments have described a case where neural network operation processing is performed by one inference operation unit 13. In contrast, in the third embodiment, inference operation indicated by a broken frame 6o in the sample code in FIG. 6 is processed in parallel using a plurality of inference operation units 13a and 13b. A description will be given below with a focus on components different from those in the first and second embodiments.

As shown in FIG. 16, an inference processing apparatus 1B includes a batch processing control unit 10, a memory control unit 11, a storage unit 12, and the plurality of inference operation units 13a and 13b.

In the present embodiment, for example, K (K is an integer not less than 2 and not more than Batch (batch size): Batch is not less than 2) inference operation units 13a and 13b are provided. The inference operation units 13a and 13b perform matrix operation of pieces X of input data and a piece W of weight data which are transferred by the memory control unit 11 in respective matrix operation units 130 which the inference operation units 13a and 13b include and output respective matrix operation results A.

In an activation function operation unit 131 which each of the plurality of inference operation units 13a and 13b includes, an activation function is applied to the matrix operation result A, and an inference result Y as output is calculated.

More concretely, if the number of pieces X of input data corresponding to the set batch size is Batch, the pieces X of input data have Batch rows and N columns. As indicated by the broken frame 6o in the sample code in FIG. 6, operation which needs to be repeated Batch times to calculate inference results Y for the data count of the pieces X of input data corresponding to the set batch size is performed in a K-pronged parallel manner in the present embodiment.

As has been described above, the inference processing apparatus 1B according to the third embodiment is provided with the K inference operation units 13a and 13b and performs, in the K-pronged parallel manner, neural network operation which needs to be repeated Batch times. This reduces the number of repetitive operations and allows speeding up of inference operation processing.

### Fourth Embodiment

A fourth embodiment of the present invention will be described. Note that the same components as those in the above-described first to third embodiments in the following description are denoted by the same reference numerals and that a description thereof will be omitted.

The first to third embodiments have described a case where the inference operation unit 13 includes only one matrix operation unit 130 to perform matrix product-sum operation. In contrast, in the fourth embodiment, an inference operation unit 13C includes a plurality of matrix operation units 130a and 130b and executes, in parallel, matrix product-sum operation indicated by a broken frame 61 in the sample code shown in FIG. 6. A description will be given below with a focus on components different from those in the first to third embodiments.

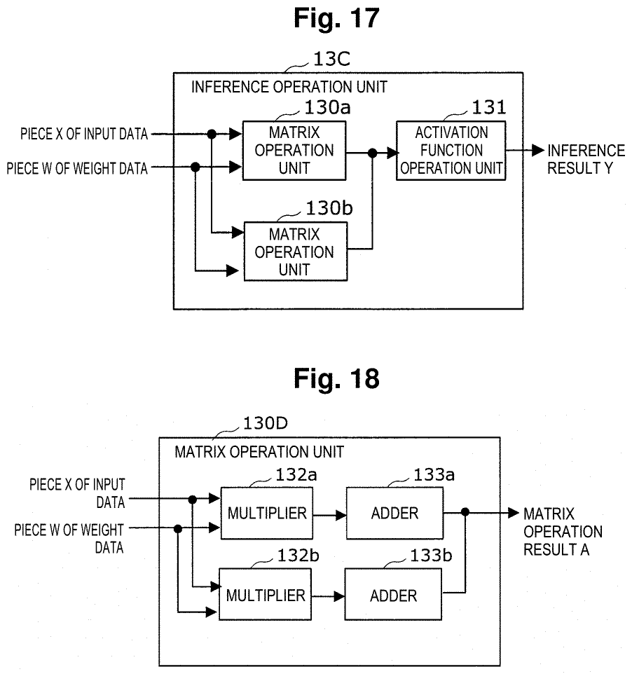

As shown in FIG. 17, the inference operation unit 13C according to the present embodiment includes the plurality of matrix operation units 130a and 130b and one activation function operation unit 131. Other components which an inference processing apparatus 1 according to the preset embodiment includes are the same as those in the inference processing apparatus 1 shown in FIG. 1.

The inference operation unit 13C includes K (K is an integer not less than 2 and not more than N) matrix operation units 130a and 130b. The K matrix operation units 130a and 130b execute matrix operation of pieces X of input data and a piece W of weight data in a K-pronged parallel manner and output a matrix operation result A. As described earlier, if the number of elements in each piece X of input data is M, and the data size of the piece W of weight data is M×N, computation for one row in the matrix operation result A having a data size of (batch size (Batch)×N) is completed by repeating product-sum operation of the matrices N times.

For example, assume a case where M=N=2, Batch=1, and there are two (K=2) matrix operation units 130a and 130b, as described with reference to FIGS. 7A and 7B. M pieces X of input data are input to each of the matrix operation units 130a and 130b. For example, elements W11 and W21 in a first column of the piece W of weight data are input to the matrix operation unit 130a, and elements W21 and W22 in a second column of the piece W of weight data are input to the matrix operation unit 130b. The memory control unit 11 can control apportionment of the piece W of weight data in accordance with the number of matrix operation units 130a and 130b.

The matrix operation unit 130a performs product-sum operation and outputs an element a1 of the matrix operation result A. The matrix operation unit 130b similarly performs product-sum operation and outputs an element a2 of the matrix operation result A. The operation results from the matrix operation units 130a and 130b are input to the activation function operation unit 131, an activation function is applied to the operation results, and an inference result Y is determined.

As has been described above, according to the fourth embodiment, the K matrix operation units 130a and 130b perform matrix operation in a K-pronged parallel manner and can reduce the number of repetitive computations in matrix operation for one row in a matrix operation result A. Especially if K=N, as in the above-described concrete example, repetition of computation is unnecessary, and a processing time period for matrix operation can be reduced. As a result, inference processing by the inference processing apparatus 1 can be speeded up.

Note that the plurality of matrix operation units 130a and 130b according to the fourth embodiment may be combined with the third embodiment. If the plurality of inference operation units 13a and 13b described in the third embodiment each include the plurality of matrix operation units 130a and 130b, inference operation can be further speeded up.

### Fifth Embodiment

A fifth embodiment of the present invention will be described. Note that the same components as those in the above-described first to fourth embodiments are denoted by the same reference numerals in the following description and that a description thereof will be omitted.

The first to fourth embodiments have described a case where the matrix operation unit 130 includes one multiplier 132 and one adder 133. In contrast, in the fifth embodiment, a matrix operation unit 130D includes a plurality of multipliers 132a and 132b and a plurality of adders 133a and 133 to perform, in parallel, internal processing in matrix operation indicated by a broken frame 62 in the sample code in FIG. 6.

As shown in FIG. 18, the matrix operation unit 130D includes K (K is an integer not less than 2 and not more than M) multipliers 132a and 132b and K adders 133a and 133b. Other components of an inference processing apparatus 1 according to the present embodiment are the same as those in the first embodiment (FIG. 1). Note that, for descriptive simplicity, a description will be given below taking, as an example, a case where M=3.

The matrix operation unit 130D performs product-sum operation of a piece X of input data and a piece W of weight data to compute elements in one row in a matrix operation result A. The matrix operation unit 130D performs product-sum operation in a K-pronged parallel manner in the K multipliers 132a and 132b and the K adders 133a and 133b. In matrix operation, product-sum operation of the piece X of input data with M elements and the piece W of weight data having a data size of M×N is performed.

For example, assume a case where two (K=2) multipliers 132a and 132b and two adders 133a and 133b are provided if M=3. Note that the piece X of input data is represented as [x1,x2,x3]. Also, assume a case where the piece W of weight data has a data size of 3×2 (M×N). A first column in the piece W of weight data is represented as W11, W21, and W31. The matrix operation result A has two elements and is represented as A[a1,a2].

In this case, for example, the element x1 of the piece X of input data and the element W11 of the piece W of weight data are input to the multiplier 132a. The element x2 of the piece X of input data and the element W21 of the piece W of weight data, and the element x3 of the piece X of input data and the element W31 of the piece of weight data are input to the multiplier 132b.

The multipliers 132a and 132b output multiplication results. In the concrete example, the multiplier 132a outputs a multiplication result x1W11, and the multiplier 132b outputs a multiplication result x2W21 and a multiplication result x₃W31. The adder 133b, adds up the multiplication results x2W21 and x3W31 from the multiplier 132b. The adder 133a adds up the multiplication result x1W11 from the multiplier 132a and an addition result (x2W21+x3W31) from the adder 133b, to output an element a1 of the matrix operation result A.

As has been described above, according to the fifth embodiment, the K multipliers 132a and 132b execute matrix multiplication of the piece X of input data and the piece W of weight data in a K-pronged parallel manner in the matrix operation unit 130D. This allows reduction in the number of repetitive computations at the time of computation of elements of the matrix operation result A. Especially if K=M, it is possible to output one element of the matrix operation result A by one computation. As a result, a processing time period for matrix operation can be reduced, and processing in the inference processing apparatus 1 can be speeded up.

Note that the fifth embodiment may be combined with the third and fourth embodiments. For example, if the matrix operation unit 130 of each of the plurality of inference operation units 13a and 13b according to the third embodiment includes the plurality of multipliers 132a and 132b according to the present embodiment, inference operation can be further speeded up, as compared to a case where only the configuration according to the third embodiment is adopted.

Also, if each of the plurality of matrix operation units 130a and 130b according to the fourth embodiment includes the plurality of multipliers 132a and 132b according to the present embodiment, matrix operation can be further speeded up, as compared to a case where only the configuration according to the fourth embodiment is adopted.

Assume a case where the configurations according to the third to fifth embodiments are adopted singly. For example, if a relationship among a batch size Batch, the number N of elements of an inference result Y, and the number M of elements of a piece X of input data satisfies Batch>B>M, processing can be made fastest in the inference processing apparatus 1B according to the third embodiment, followed by the fourth embodiment and the fifth embodiment.

Note that, if M=2 in the present embodiment, one adder 133 may be provided. Multiplication processing is executed in parallel in that case as well, and matrix operation can be speeded up. The present embodiment is more effective especially if M is not less than 4.

### Sixth Embodiment

A sixth embodiment of the present invention will be described. Note that the same components as those in the above-described first to fifth embodiments are denoted by the same reference numerals in the following description and that a description thereof will be omitted.

The first to fifth embodiments have described a case where a piece W of weight data is stored in advance in the storage unit 12. In contrast, an inference processing apparatus 1E according to the sixth embodiment includes a wireless communication unit 15 which receives a piece W of weight data via a communication network NW.

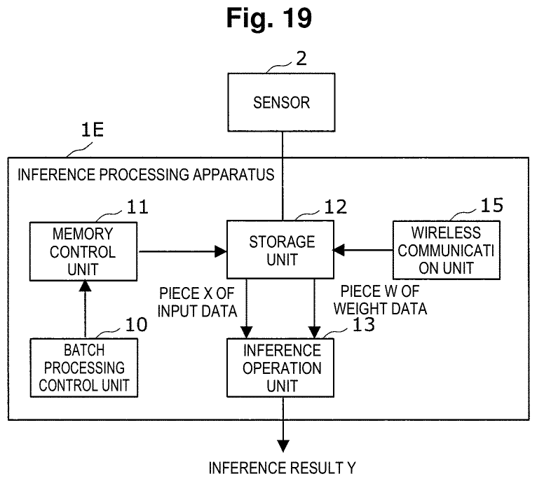

As shown in FIG. 19, the inference processing apparatus 1E according to the sixth embodiment includes a batch processing control unit 10, a memory control unit 11, a storage unit 12, an inference operation unit 13, and the wireless communication unit 15.

The wireless communication unit 15 receives a piece W of weight data of a neural network model which is to be used in the inference processing apparatus 1E from an external cloud server or the like via the communication network NW and stores the piece W of weight data in the storage unit 12. In, for example, a case where the piece W of weight data of the neural network model to be used in the inference processing apparatus 1E is updated through relearning, the wireless communication unit 15 downloads the updated piece W of weight data through wireless communication and rewrites the old piece W of weight data stored in the storage unit 12.

When inference processing is to be performed using another neural network model in the inference processing apparatus 1E, the wireless communication unit 15 receives a piece W of weight data of the new learned neural network which is received from the external cloud server or the like and stores the piece W of weight data in the storage unit 12.

As described above, the inference processing apparatus 1E according to the sixth embodiment can rewrite a piece W of weight data of a neural network model, and an optimum piece W of weight data can be used in the inference processing apparatus 1E. This makes it possible to prevent inference precision from declining due to, e.g., variation between pieces X of input data.

Embodiments of an inference processing apparatus and an inference processing method according to the present invention have been described above. The present invention, however, is not limited to the described embodiments. Various types of modifications which can be arrived at by those skilled in the art within the scope of the invention stated in the claims can be made.

For example, functional units except for an inference operation unit in an inference processing apparatus according to the present invention can also be implemented by a computer and a program, and the program can be recorded on a recording medium or be provided through a network.

### REFERENCE SIGNS LIST

1 Inference processing apparatus
2 Sensor
10 Batch processing control unit
11 Memory control unit
12 Storage unit
13 Inference operation unit
120 Input data storage unit
121 Learned NN storage unit
15 Wireless communication unit
130 Matrix operation unit
131 Activation function operation unit
132 Multiplier
[016o] 133 Adder
101 Bus
102 Processor
103 Main storage device
104 Communication interface
105 Auxiliary storage device
106 I/O device
107 Display device.

1.-8. (canceled)

9. An inference processing apparatus comprising:
a first storage device configured to store input data;
a second storage device configured to store a weight of a neural network;
a batch processing controller configured to set a batch size on in accordance with the input data;
a memory controller configured to read out, from the first storage device, a piece of the input data corresponding to the batch size; and
an inference operation device configured to:
batch-process operation in the neutral network using, as an input, the piece of the input data corresponding to the batch size and the weight; and
infers a feature of the piece of the input data.

10. The inference processing apparatus according to claim 9, wherein the batch processing controller is configured to set the batch size in accordance with hardware resources of the inference operation device.

11. The inference processing apparatus according to claim 9, wherein:
the inference operation device includes:
a matrix operation device configured to perform matrix operation of the piece of the input data and the weight; and
an activation function operation device configured to apply an activation function to a matrix operation result of the matrix operation device; and
the matrix operation device includes
a multiplier configured to multiply the piece of the input data and the weight; and
an adder configured to add a multiplication result of the multiplier.

12. The inference processing apparatus according to claim 11, wherein the matrix operation device comprises a plurality of matrix operation devices, and the plurality of matrix operation devices are configured to perform matrix operation in parallel.

13. The inference processing apparatus according to claim 11, wherein the multiplier comprises a plurality of multipliers, and wherein the plurality of multipliers are configured to perform multiplication in parallel.

14. The inference processing apparatus according to claim 11, wherein the adder comprise a plurality of adders, and wherein the plurality of adders are configured to perform addition in parallel.

15. The inference processing apparatus according to claim 9, further comprising:
a data convertor configured to converts a data type of the piece of the input data and a data type of the weight to be input to the inference operation device.

16. The inference processing apparatus according to claim 9, wherein the inference operation device comprises a plurality of inference operation devices, and wherein the plurality of inference operation devices perform inference operation in parallel.

17. An inference processing method comprising:
setting a batch size in accordance with input data that is stored in a first storage device of an inference processing apparatus;
reading out, from the first storage device, a piece of the input data corresponding to the batch size;
batch-processing operation in a neural network using, as input, the piece of the input data corresponding to the batch size and a weight of the neural network that is stored in a second storage device; and
inferring a feature of the piece of the input data.

18. The inference processing method according to claim 17 further comprising setting the batch size in accordance with hardware resources used for inference operations in the inference processing apparatus.

19. The inference processing method according to claim 17 further comprising converting a data type of the piece of the input data and a data type of the weight prior to inferring the feature of the piece of the input data.
